(19) United States
(12) Patent Application Publication
(10) Pub. No.: US 2015/0143467 A1
(43) Pub. Date: May 21, 2015

(54) SYSTEM AND METHOD FOR FACILITATING COMMUNICATION BETWEEN A WEB APPLICATION AND A LOCAL PERIPHERAL DEVICE THROUGH A NATIVE SERVICE

(71) Applicant: Intel-GE Care Innovations LLC, Roseville, CA (US)

(72) Inventors: Kevin Hebert, Roseville, CA (US); Jason Smith, Roseville, CA (US); Jesjit Birak, Roseville, CA (US)

(73) Assignee: Intel-GE Care Innovations LLC, Roseville, CA (US)

(21) Appl. No.: 14/083,840

(22) Filed: Nov. 19, 2013

(51) Int. Cl. H04L 29/08; H04L 29/06

(52) U.S. Cl. CPC H04L 67/10; H04L 63/10
USPC 726/4; 709/203

(57) ABSTRACT

The disclosure relates to systems and methods for facilitating communication between a web application and a local peripheral device through a native service where the local peripheral device is locally connected to a computer having the native service. To access data associated with the local peripheral device, a browser may make a cross-domain request to the native service that resides in a domain that is different from the domain that served the web application. Prior to sending the actual cross-domain request, the browser may send a pre-flight cross-domain request to the native service. The native service may send a response to the pre-flight request to the browser. The response may comprise information related to whether the cross-domain request can be serviced by the native service. The browser may send the cross-domain request to the native service, which may comprise functions to be executed on the local peripheral device.

### FIELD OF THE INVENTION

The disclosure relates to systems and methods for facilitating communication between a web application and a local peripheral device through a native service where the local peripheral device is locally connected to a computer having the native service.

### BACKGROUND OF THE INVENTION

Generally, communication between a web application and peripherals locally connected to a personal computing device can be established via a web browser enabled with a browser extension, plugin, or add-on software on the computing device. Establishing the communication in this way requires the end users to install such browser extensions, plugins, or add-on software on their computing device. Developers of a web application are required to build specific browser extensions, plugins, or add-on software for all types of web browsers they intend to use with their web application, adding to the cost of development. Moreover, web browser plugins have historically had both compatibility and security issues, requiring frequent user updates.

As such, what is needed is to be capable of facilitating communication between a web application and a local peripheral device without the use of browser extensions, plugin, or add-on software. These and other problems exist.

### SUMMARY OF THE INVENTION

One aspect of the disclosure relates to systems and methods for facilitating communication between a web application and a local peripheral device through a native service where the local peripheral device is locally connected to a computer having the native service.

The web application may be accessed by a browser running on the computer. To access data associated with the local peripheral device, the browser may make a cross-domain request to the native service that resides in a domain that is different from the domain that served the web application. Prior to sending the actual cross-domain request, the browser may send a pre-flight cross-domain request to the native service. The native service may generate and/or transmit a response to the pre-flight request to the browser. The response may comprise information related to whether the cross-domain request can be serviced by the native service. For example, the response may include information related to whether the native service is properly installed and running on the computer, whether an appropriate software driver for the local peripheral device is properly installed and running on the computer, and/or other information.

The browser may determine whether to send the actual cross-domain request based on the received response from the native service and/or send the cross-domain request to the native service. The native service may verify the cross-domain request based on an authorization ticket. The cross-domain request may comprise one or more functions to be executed on the local peripheral device. For example, the cross-domain request may cause the native service to obtain measurements data from a medical peripheral device locally connected to the computer and/or transmit the obtained data to the web application via the browser.

In one embodiment, there is provided a system comprising: a computer device comprising a browser configured to access a web application via a communication network; a native service configured to communicate with one or more peripheral devices locally connected to the computer device, the native service comprising one or more computer program modules; and one or more processors programmed by the one or more computer program modules. The one or more computer program modules comprises a request handling module configured to: receive a cross-domain request from the browser, the cross-domain request comprising one or more functions to be executed on at least one of the one or more peripheral devices; and execute the one or more functions on the at least one of the one or more peripheral devices.

In another embodiment, there is provided a method implemented in a computer that includes one or more processors configured to execute one or more computer program instructions. The method comprises: receiving, at a native service, a pre-flight cross-domain request from a browser prior to receiving a cross-domain request; determining whether the cross-domain request can be serviced by the native service; generating a response to the pre-flight cross-domain request based on the determination; receiving the cross-domain request from the browser, the cross-domain request comprising one or more functions to be executed at a locally connected peripheral device; and executing the one or more functions on the locally connected peripheral device.

In another embodiment, there is provided a web server configured to provide a web application that comprises one or more GUI objects which, when interacted with by a user using a browser running on a computer device, cause the browser to generate a cross-domain request that comprises one or more functions to be executed on a peripheral device locally connected to the computer device. The web server comprises one or more processors configured to: provide the web application that is accessible through the browser, wherein the web application comprises a GUI object which when interacted with by the user using the browser causes a native application running on the computer device to execute one or more functions on a peripheral device that is locally connected to the computer device; detect when the GUI object has been interacted with by the user using the browser; and cause the browser to generate the cross-domain request upon the detection, wherein the cross-domain request comprises the one or more functions to be executed on the peripheral device.

In another embodiment, there is provided a method implemented in a computer that includes one or more processors configured to execute one or more computer program instructions. The method comprises: providing a web application that is accessible through a browser running on a computer device, wherein the web application comprises a GUI object which when interacted with by a user using the browser causes a native application running on the computer device to execute one or more functions on a peripheral device that is locally connected to the computer device; detecting when the GUI object has been interacted with by the user using the browser; and causing the browser to generate a cross-domain request upon the detection, wherein the cross-domain request comprises the one or more functions to be executed on the peripheral device.

In another embodiment, there is provided a non-transitory computer readable medium storing computer-readable instructions that, when executed by one or more processors, cause a computer device to: receive, by a request handling module, a cross-domain request from a browser, the cross-domain request comprising a request to obtain measurement data from a medical peripheral device that is locally connected to the computer device; obtain, by the request handling module, the measurement data from the medical peripheral device; and transmit, by the request handling module, the obtained measurement data to the browser.

Other objects and advantages of the invention will be apparent to those skilled in the art based on the following drawings and detailed description. It also is to be understood that both the foregoing general description and the following detailed description are exemplary and not restrictive of the scope of the embodiments.

### BRIEF DESCRIPTION OF THE DRAWINGS

FIG. 1 illustrates a system for facilitating communication between a web application and a local peripheral device through a native service, according to an aspect of the invention.

FIG. 2 illustrates a process for facilitating communication between a web application and a local peripheral device through a native service, according to an aspect of the invention.

FIG. 3 illustrates a data flow diagram for a system for facilitating communication between a web application, a browser, and a native service, according to an aspect of the invention.

FIG. 4 illustrates a screenshot of an interface for initiating a cross-domain request to obtain measurements data from a medical peripheral device, according to an aspect of the invention.

### DETAILED DESCRIPTION OF THE INVENTION

One aspect of the disclosure relates to systems and methods for facilitating communication between a web application and a local peripheral device through a native service where the local peripheral device is locally connected to a computer having the native service.

The “Cross-Origin Resource Sharing (CORS)” may be a mechanism implemented in web browsers (e.g., CORS-enabled browsers), which allows a browser accessing a web application served by a first web server to make a request (e.g., HTTP request, etc.) to another domain (e.g., a second web server) other than the domain (i.e., the first web server) that served the web application. Such “cross-domain” requests would otherwise be prohibited by the browser's same-origin policy (SOP) which requires requests to be made to the same domain that served the web application. The CORS, therefore, is a useful technique for relaxing the SOP while handling cross-domain requests in a secure manner.

The “native service” (used interchangeably with “native application” herein) may comprise a software application locally installed and running on a computer. In some embodiments, the native service may host (and/or act as) a web server that may receive cross-domain requests (e.g., CORS requests) originated from a web application served by a different domain or web server. In some embodiments, the cross-domain requests may include a request to obtain (or otherwise access) data from one or more peripheral devices locally connected to the computer. In these embodiments, the native service may authenticate to the web application on behalf of the one or more locally connected peripheral devices and/or provide a secure communication channel between the browser accessing the web application and the one or more locally connected peripheral devices. In some embodiments, the native service may be responsible for translating messages between the web application/browser and the one or more locally connected peripheral devices. In some embodiments, the native service may be installed as a Windows service, started automatically at boot time.

The “local peripheral device” (used interchangeably with “locally connected peripheral device” herein) may comprise a peripheral device that is locally connected to a computer via a local communication network including but not limited to: USB interface, Bluetooth, Local Area Network (LAN), Wireless LAN (WLAN), WiFi, WiGig, ZigBee, Radio Frequency, and/or other local network connections. In some embodiments, the local peripheral device may include a medical peripheral device (used interchangeably with a “measurement device,” “monitoring device,” and “biometric device” herein). The medical peripheral device may include but not limited to: a glucose meter, pulse oximeter, blood pressure cuff, weight scale, and/or spirometer.

Other implementations and uses of the system will be apparent based on the disclosure herein. Having provided a broad overview of a use of the system, various system components will now be described.

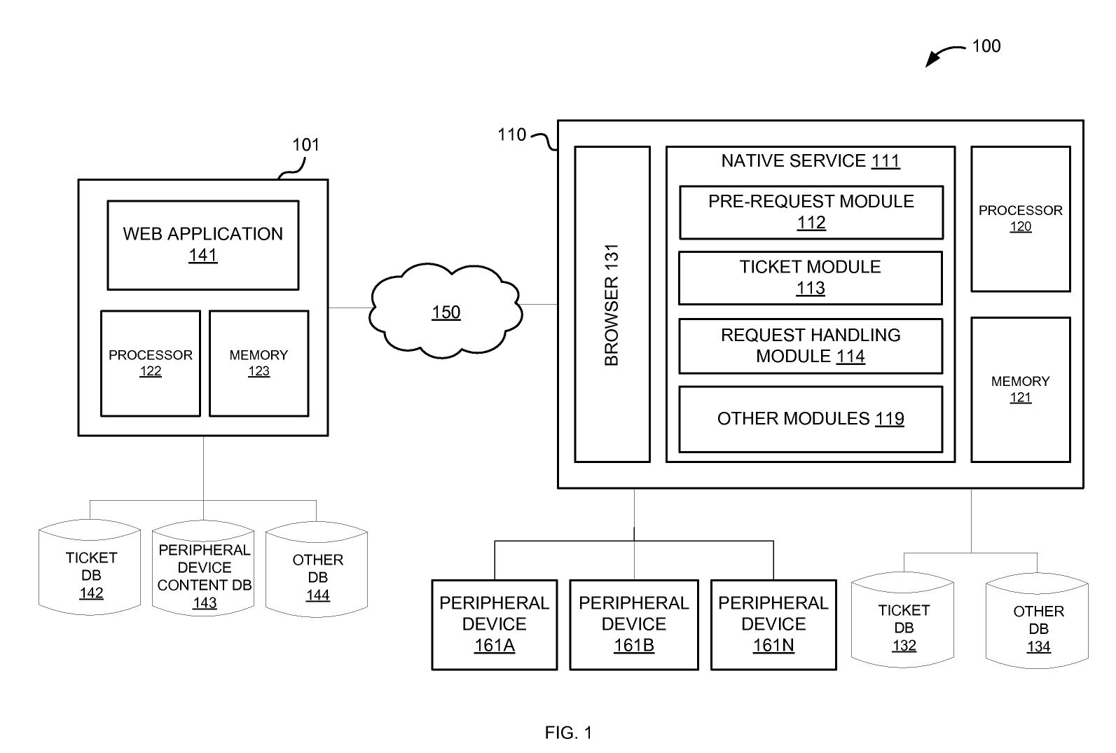

FIG. 1 illustrates a system 100 for facilitating communication between a web application and a local peripheral device through a native service, according to an aspect of the invention. In some embodiments, system 100 may include a server 101, a computer 110, local peripheral devices 161 (illustrated in FIG. 1 as local peripheral devices 161A, 161B, . . . , 161N), a network 150, and/or other components.

Server 101 may comprise a web server having a web application 141 that may be accessed by computer 110 via a communication network such as the Internet using a browser 131. In some embodiments, browser 131 may comprise a CORS-enabled browser and/or other browsers capable of handling cross-domain requests.

In some embodiments, web application 141 may be or include a medical application that may create, gather, maintain, and/or manage health/medical information and/or other information related to patients. For example, the medical application may obtain health measurements (e.g., blood pressure, weight, etc.) from one or more peripheral devices 161 connected to computer 110. In this example, the medical application may comprise a web portal and/or one or more applets. A user (e.g., patient) may interact with server 101 by accessing the web portal via browser 131 from computer 110. The user may, via the web portal, instruct the medical application to perform one or more functionalities including: registering, logging on, configuring and managing workspace and account, configuring and managing calendar and notification, performing health sessions, reviewing clinical content, and/or taking measurements (e.g., blood pressure, weight, etc.) with medical peripherals devices.

These functionalities and/or other functionalities of the medical application may be provided and/or supported by the one or more applets. An applet is a set of features providing a cohesive set of functionality. The one or more applets may include, for example, a calendar and notification applet (e.g., creating, receiving, viewing, and/or managing calendar events, assigning participants to the calendar event, generating and/or sending alerts/notifications, etc.), contacts manager applet (e.g., entering, editing, viewing, and deleting contacts), measurements applet (e.g., capturing and/or obtaining vital sign measurements from one or more medical peripheral devices), health assessments applet (e.g., creating, viewing, and/or managing a health session during which various health measurements may be taken and health assessments may be conducted, accessing a session summary and/or detailed session history, creating, sending, and/or managing reminders for the health session, requesting Protected Health Information (PHI) view, etc.), medications applet (e.g., creating, editing, and deleting medications, setting calendar reminders for medications and tasks for medication refills), workspace/account manager applet (e.g., creating personal or group workspace for use by registered users, managing user accounts, profiles, workspace membership, access permissions, etc.), learn more applet (e.g., accessing clinical content) and/or other applets.

In some embodiments, computer 110 may include one or more computers configured to execute a native service 111. Native service 111 may comprise one or more computer program modules. Through these program modules, computer 110 may identify a port that may be used for communication between web application 141/browser 131 and native service 111, receive a pre-flight cross-domain request that may be used to determine whether a cross-domain request can be serviced by native service 111, obtain an authorization ticket that may be used to authenticate web application 141 (and/or requests originated from web application 141 and/or made to native service 111) to native service 111, receive a cross-domain request that may comprise one or more functions to be executed on one or more local peripheral devices 161, verify the cross-domain request based on the authorization ticket, execute the one or more functions on the one or more local peripheral devices 161, and/or perform other functions.

Web application 141 may be accessed by browser 131 running on computer 110. To access data associated with the a local peripheral device (e.g., local peripheral device 161A), browser 131 may make a cross-domain request to native service 111 that resides in a domain that is different from the domain that served web application 141. Prior to sending the actual cross-domain request, browser 131 may send a pre-flight cross-domain request to native service 111. Native service 111 may generate and/or transmit a response to the pre-flight request to browser 131. The response may comprise information related to whether the cross-domain request can be serviced by native service 111. For example, the response may include information related to whether native service 111 is properly installed and running on computer 110, whether an appropriate software driver for local peripheral device 161A is properly installed and running on computer 110, and/or other information.

Browser 131 may determine whether to send the actual cross-domain request based on the received response from native service 111 and/or send the cross-domain request to native service 111. Native service 111 may verify the cross-domain request based on an authorization ticket. The cross-domain request may comprise one or more functions to be executed on local peripheral device 161A. For example, the cross-domain request may cause native service 111 to obtain measurements data from a medical peripheral device 161A locally connected to computer 110 and/or transmit the obtained data to web application 141 via browser 131.

The computer program modules may include one or more of a pre-request module 112, a ticket module 113, a request handling module 114, and/or other modules 119 for performing the functions described herein.

In some embodiments, pre-request module 112 may be configured to identify and/or determine a port (e.g., TCP port) that may be used for communication between web application 141/browser 131 and native service 111. It may start at the last known port number that native service 111 used. If there is no port number stored in the registry and/or the last known port number is no longer available, browser 131 may negotiate a port from a predefined range of ports that can be used by native service 111 for communication. For example, the first available port starting at the beginning of the predefined port range may be selected for communication. The selected port number may be stored in the registry. Once the port is identified and/or determined, web application 141 and/or browser 131 may send one or more requests (e.g., pre-flight cross-domain requests, actual cross-domain request, etc.) over the identified port.

In some embodiments, web application 141 may initiate a communication with native service 111 to gain access to data associated with one or more local peripheral devices 161. For example, while accessing web application 141 via browser 131, a user may select to “take measurements” from one or more local peripheral devices 161 by clicking or otherwise selecting one or more Graphical User Interface (GUI) elements (e.g., GUI buttons) displayed on the web page provided by web application 141. This may cause browser 131 to send a cross-domain request to native service 111. Browser 131 (e.g., a CORS-enabled browser and/or other browsers capable of handling cross-domain requests) may send the cross-domain request to native service 111 that resides in a domain that is different from the domain that serviced web application 141 using the CORS technology and/or other similar technologies, as apparent to those skilled in the art.

In some embodiments, prior to sending the actual cross-domain request, browser 131 may send a pre-flight cross-domain request to native service 111. Browser 131 (e.g., a CORS-enabled browser and/or other browsers capable of handling cross-domain requests) may transmit the pre-flight request to native service 111 using the CORS technology and/or other similar technologies, as apparent to those skilled in the art.

In some embodiments, the pre-flight request may cause computer 110 to determine whether native service 111 is properly installed and running on computer 110. In some embodiments, the pre-flight request may cause computer 110 to determine whether an appropriate software driver for the one or more peripheral devices 161 is properly installed and running on computer 110.

In some embodiments, pre-request module 112 may be configured to generate and/or transmit a response to the pre-flight cross-domain request to browser 131. The response may comprise information related to whether the cross-domain request can be serviced by native service 111. For example, the response may include information related to whether native service 111 is properly installed and running on computer 110, whether an appropriate software driver for the one or more peripheral devices 161 is properly installed and running on computer 110, and/or other information. Browser 131 may determine whether to send the actual cross-domain request based on the received response from native service 111 and/or send the cross-domain request to native service 111 over the identified port.

In some embodiments, in order to authenticate a request made to native service 111, an authorization ticket may be used. For example, native service 111 may use authorization tickets to authenticate web application 141 (and/or requests originated from web application 141 and/or made to native service 111) to native service 111. If the request is authenticated based on a proper authorization ticket, the request may be authorized to be submitted to native service 111.

In some embodiments, browser 131 may “ping” native service 111. In some embodiments, the ping request may cause native service 111 to determine whether web application 141/browser 131 is authorized to access native service 111. If an authorization ticket has not yet been provided by web application 141, it has been provided but failed verification tests, or is otherwise unavailable, ticket module 113 may be configured to generate a response indicating that the access could not be authorized (e.g., HTTP status 401, access-denied response) and/or that an authorization ticket is required. Ticket module 113 may send the generated response to web application 141 via browser 131 to request for a new authorization ticket.

In some embodiments, web application 141 may generate an authorization ticket and/or store the ticket in ticket database 142 and/or other databases 144. Web application 141 may send the authorization ticket comprising ticket information to native service 111. For example, the ticket information may comprise a time frame (e.g., start time and end time) that indicates how long the ticket should remain valid. Ticket module 113, upon receiving the ticket and/or ticket information, may certify the ticket by assigning a Ticket ID (e.g., globally unique identifier (guid)) to the authorization ticket. The Ticket ID may be associated with native service 111 that generated the Ticket ID and/or computer 110 on which native service 111 is installed.

In some embodiments, ticket module 113 may return the certified ticket comprising ticket certification information to web application 141 where the ticket certification information may comprise the Ticket ID associated with the authorization ticket and/or a time frame that indicates how long the ticket should remain valid. Web application 141 may determine whether the Ticket ID is valid (e.g., the guid is not the ‘empty’ guid). Web application 141 may determine whether the time frame indicated in the ticket certification returned matches the time frame indicated in the ticket information sent. This may prevent an attacker from changing the time frame to a range that is much wider than intended.

In some embodiments, web application 141 may sign the ticket based on the ticket certification. The ticket (e.g., stored in ticket database 142) may be updated with the signature and/or stored as a valid ticket. Web application 141 may send the signed ticket back to native service 111 via browser 131. In some embodiments, the signature may comprise a digital signature that may be used to verify that the ticket was created by an authorized program and/or may be used as a password for the login (e.g., Ticket ID). The signed ticket may comprise the signature, the Ticket ID, the time frame information, and/or other information. In some embodiments, browser 131 may store a copy of the signed ticket in a local storage.

In response to receiving the signed ticket from web application 141, ticket module 113 may be configured to verify, confirm, and/or store the signed ticket in ticket database 132 and/or other databases 134. For example, ticket module 113 may check the Ticket ID and time frame to confirm that they match the corresponding information in the signed ticket.

In some embodiments, request handling module 114 may be configured to obtain the cross-domain request originated from web application 141. In some embodiments, request handling module 114 may be configured to verify the cross-domain request based on an authorization ticket (discussed herein with respect to ticket module 113). The cross-domain request may be associated with a Ticket ID, a signature, a timestamp, and/or other authorization information. For example, the timestamp may indicate date and time information at which the cross-domain request was generated and/or sent to native service 111. Request handling module 114 may identify a signed ticket (e.g., stored in ticket database 132) that corresponds to the Ticket ID associated with the cross-domain request. Request handling module 114 may verify that the timestamp falls within the time frame specified in and/or associated with the signed ticket. The cross-domain request may be verified against the signature specified in and/or associated with the signed authorization ticket. For example, the signature associated with the cross-domain request may be compared against the signature of the signed authorization ticket to determine whether they match.

In some embodiments, if the authorization ticket has not been provided by web application 141, it has been provided but failed the verification tests, or is otherwise unavailable, ticket module 113 may request a new authorization ticket from web application 141, as discussed herein with respect to ticket module 113. Once verified, the cross-domain request and/or one or more functions defined in the request may be serviced and/or processed by native service 111.

In some embodiments, the cross-domain request may comprise one or more functions to be executed on the one or more local peripheral devices 161. The one or more functions defined in the cross-domain request may include retrieving, inserting, modifying, deleting, or otherwise accessing data that may be associated with at least one of the one or more local peripheral devices 161 and/or that may be stored in a data storage coupled to the at least one of the one or more local peripheral devices 161, and/or other functions. In one example, when a user, via browser 131, selects to “take measurements” from a particular medical peripheral device 161 by clicking or otherwise selecting a GUI button displayed on the web page provided by web application 141, request handling module 114 may obtain a cross-domain request from browser 131 where the one or more functions defined in the cross-domain request include accessing and/or retrieving measurements data from the medical peripheral device 161. The user may take the measurements using the medical peripheral device 161. For example, the user may measure blood pressure using a blood pressure monitoring device.

In some embodiments, in response to the cross-domain request, request handling module 114 may retrieve and/or obtain the requested measurements data from the medical peripheral device 161 and/or a data storage coupled to the medical peripheral device 161. For example, request handling module 114 may retrieve and/or obtain the blood pressure data from the blood pressure monitoring device. The obtained measurements data may be transmitted to web application 141 via browser 131, and/or stored in a peripheral device content database 143 and/or other databases 144.

In some embodiments, native service 111 may be configured to convert text to speech. For example, during a measurement capture, browser 131 may send measurement instructions in text to native service 111. The received text may be converted by native service 111 to speech such that the measurement instructions may be spoken to the user.

Other uses and implementations of computer 110 will be apparent to those having skill in the art based on the disclosure herein.

Server 101 may include one or more processors 122, a memory 123, and/or other components. Server 101 may include communication lines, or ports to enable the exchange of information with a network and/or other computing platforms. Illustration of server 101 in FIG. 1 is not intended to be limiting. Server 101 may include a plurality of hardware, software, and/or firmware components operating together to provide the functionality attributed herein to server 101. For example, server 101 may be implemented by a cloud of computing platforms operating together as server 101. The cloud-based server may run in a public cloud, a private cloud, and/or a hybrid cloud.

In some embodiments, server 101 may include or otherwise access various databases to store and/or retrieve information. The various databases may include, for example, a ticket database 142, peripheral device content database 143, and/or other databases 144. Ticket database 142 may store one or more authorization tickets. Peripheral device content database 143 may store data, content, and/or resources acquired, retrieved, and/or obtained from one or more peripheral devices 161.

Computer 110 may include one or more processors 120, a memory 121, and/or other components. Computer 110 may include communication lines, or ports to enable the exchange of information with a network and/or other computing platforms. Illustration of computer 110 in FIG. 1 is not intended to be limiting. One or more processors 120 may be configured to execute the computer program modules as discussed herein. The computer program modules may be configured to enable an expert or user associated with computer 110 to interface with server 101 and/or peripheral devices 161, and/or provide other functionality attributed herein to computer 110.

In some embodiments, computer 110 may include or otherwise access various databases to store and/or retrieve information. The various databases may include, for example, ticket database 132, and/or other databases 134. Ticket database 132 may store one or more authorization tickets.

In some embodiments, computer 110 may include a mobile device, one or more computing devices (e.g., specialty computing systems, desktop computers, personal computers, mobile computing devices, tablet computing devices, smart-phones, or other computing devices) having one or more processors (e.g., microprocessors), memory devices (e.g., hard disk, RAM, EEPROM, etc.), input/output components, and/or other computing components for performing the features and functions described herein (and/or other features and functions). Each of the foregoing devices may have one or more user interfaces such as a keypad, a display, a voice recognition microphone and speaker to interact with a user. In some embodiments, each of the foregoing devices comprises processor 120 coupled to memory 121 over a bus to carry out the features and functionalities of the embodiments described herein. In some embodiments, each of the foregoing devices comprises one or more computer program modules residing in the memory thereof and generating a display that is displayed to the user via the display. Each of the foregoing devices may have an antenna to wirelessly communicate with other components of system 100 over network 150 or independent of network 150.

In some embodiments, network 150 may be or include a communications network capable of supporting one or more modes of communications, including but not limited to, wireless, wired, and optical communications. For example, network 150 may comprise cell phone towers or other wireless communication infrastructure, public switched telephone networks (PSTN), active and passive optical networks, and combinations thereof. Examples of such networks may include computer implemented networks such as the Internet, a local area network (LAN), a wide area network (WAN), etc.

The databases 132, 134, 142, 143, 144, and/or other data storages described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The foregoing description of the various components comprising system 100 is exemplary only, and should not be viewed as limiting. The invention described herein may work with various system configurations. Accordingly, more or less of the aforementioned system components may be used and/or combined in various implementations.

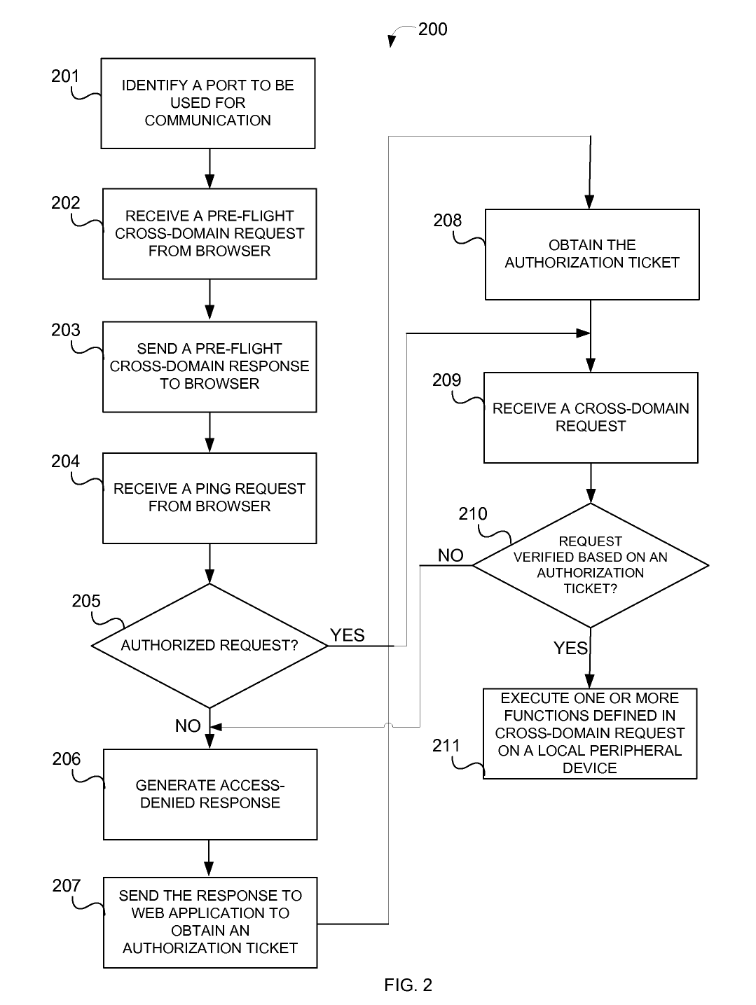

FIG. 2 illustrates a process 200 for facilitating communication between a web application and a local peripheral device through a native service, according to an aspect of the invention. The various processing operations and/or data flows depicted in FIG. 2 (and in the other drawing Figures) are described in greater detail herein. The described operations may be accomplished using some or all of the system components described in detail above and, in some embodiments, various operations may be performed in different sequences. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 201, process 200 may include identifying and/or determining a port (e.g., TCP port) that may be used for communication between web application 141/browser 131 and native service 111. It may start at the last known port number that native service 111 used. If there is no port number stored in the registry and/or the last known port number is no longer available, browser 131 may negotiate a port from a predefined range of ports that can be used by native service 111 for communication. For example, the first available port starting at the beginning of the predefined port range may be selected for communication. The selected port number may be stored in the registry. Once the port is identified and/or determined, web application 141 and/or browser 131 may send one or more requests (e.g., pre-flight cross-domain requests, actual cross-domain request, etc.) over the identified port.

In an operation 202, process 200 may include receiving a pre-flight cross-domain request from browser 131. In some embodiments, the pre-flight request may cause computer 110 to determine whether native service 111 is properly installed and running on computer 110. In some embodiments, the pre-flight request may cause computer 110 to determine whether an appropriate software driver for the one or more peripheral devices 161 is properly installed and running on computer 110.

In an operation 203, process 200 may include generating and/or transmitting a response to the pre-flight cross-domain request to browser 131. The response may comprise information related to whether the cross-domain request can be serviced by native service 111. For example, the response may include information related to whether native service 111 is properly installed and running on computer 110, whether an appropriate software driver for the one or more peripheral devices 161 is properly installed and running on computer 110, and/or other information. Browser 131 may determine whether to send the actual cross-domain request based on the received response from native service 111 and/or send the cross-domain request to native service 111 over the port identified in operation 201.

In an operation 204, process 200 may include receiving a ping request from browser 131. In an operation 205, process 200 may include determining whether web application 141/browser 131 is authorized to access native service 111. If an authorization ticket has not yet been provided by web application 141, it has been provided but failed verification tests, or is otherwise unavailable, process 200 may proceed to an operation 206. On the other hand, if process 200 determines that the web application 141/browser 131 is authorized to access native service 111, process 200 may proceed to an operation 209.

In operation 206, process 200 may include generating a response indicating that the access could not be authorized (e.g., HTTP status 401, access-denied response) and/or that an authorization ticket is required.

In an operation 207, process 200 may include sending the generated response to web application 141 via browser 131 to request for a new authorization ticket.

In an operation 208, process 200 may include obtaining the authorization ticket. The obtained authorization ticket may comprise a Ticket ID, a time frame that may indicate how long the authorization ticket should remain valid, a digital signature, and/or other authorization information.

In operation 209, process 200 may include obtaining a cross-domain request originated from web application 141. In some embodiments, the cross-domain request may comprise one or more functions to be executed on a local peripheral device 161. The one or more functions defined in the cross-domain request may include retrieving, inserting, modifying, deleting, or otherwise accessing data that may be associated with the local peripheral device 161 and/or that may be stored in a data storage coupled to the at least one of the local peripheral device 161, and/or other functions. In one example, when a user, via browser 131, selects to “take measurements” from a particular medical peripheral device 161 by clicking or otherwise selecting a GUI button displayed on the web page provided by web application 141, request handling module 114 may obtain a cross-domain request from browser 131 where the one or more functions defined in the cross-domain request include accessing and/or retrieving measurements data from the medical peripheral device 161.

In an operation 210, process 200 may include verifying the cross-domain request based on an authorization ticket. The cross-domain request may be associated with a Ticket ID, a signature, a timestamp, and/or other authorization information. For example, the timestamp may indicate date and time information at which the cross-domain request was generated and/or sent to native service 111. Process 200 may include identifying a signed ticket (e.g., stored in ticket database 132) that corresponds to the Ticket ID associated with the cross-domain request. Process 200 may verify that the timestamp falls within the time frame specified in and/or associated with the signed ticket. The cross-domain request may be verified against the signature specified in and/or associated with the signed authorization ticket. For example, the signature associated with the cross-domain request may be compared against the signature of the signed authorization ticket to determine whether they match.

If the authorization ticket has not been provided by web application 141, it has been provided but failed the verification tests, or is otherwise unavailable, process 200 may return to operation 206. Once verified, process 200 may proceed to an operation 211.

In operation 211, process 200 may include executing the one or more functions defined in the cross-domain request on the local peripheral device 161. For example, process 200 may retrieve and/or obtain the requested measurements data from the medical peripheral device 161 and/or a data storage coupled to the medical peripheral device 161. For example, process 200 may retrieve and/or obtain blood pressure data from a blood pressure monitoring device. The obtained measurements data may be transmitted to web application 141 via browser 131, and/or stored in a peripheral device content database 143 and/or other databases 144.

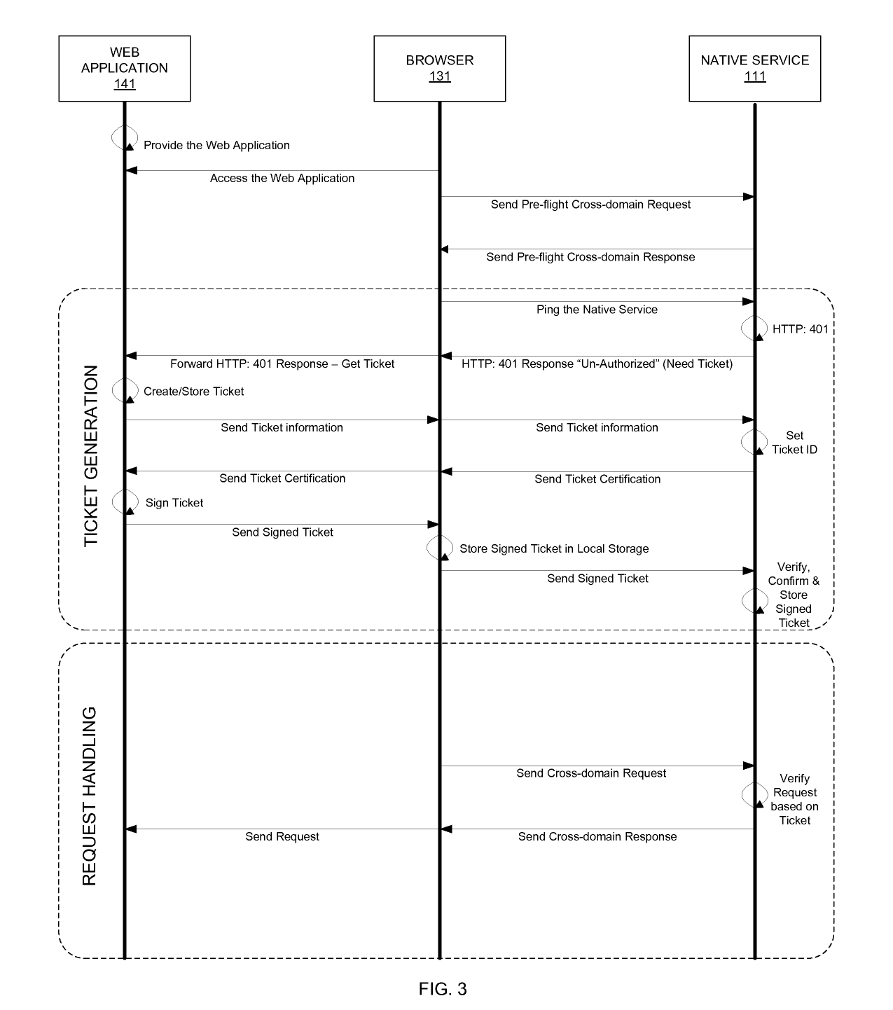

FIG. 3 illustrates a data flow diagram for a system for facilitating communication between a web application, a browser, and a native service, according to an aspect of the invention.

Web application 141 may provide a web page that may be accessed by a user via browser 131. For example, a user may interact with server 101 by accessing the web page via browser 131 from computer 110.

In some embodiments, web application 141 may initiate a communication with native service 111 to gain access to data associated with one or more local peripheral devices 161. For example, while accessing web application 141 via browser 131, a user may select to “take measurements” from one or more local peripheral devices 161 by clicking or otherwise selecting one or more Graphical User Interface (GUI) elements (e.g., GUI buttons) displayed on the web page provided by web application 141. This may cause browser 131 to send a cross-domain request to native service 111. Browser 131 (e.g., a CORS-enabled browser and/or other browsers capable of handling cross-domain requests) may send the cross-domain request to native service 111 that resides in a domain that is different from the domain that served web application 141 using the CORS technology and/or other similar technologies, as apparent to those skilled in the art.

In some embodiments, prior to sending the actual cross-domain request, browser 131 may send a pre-flight cross-domain request to native service 111. Browser 131 may transmit the pre-flight request to native service 111 using the CORS technology and/or other similar technologies, as apparent to those skilled in the art. In some embodiments, the pre-flight request may cause computer 110 to determine whether native service 111 is properly installed and running on computer 110. In some embodiments, the pre-flight request may cause computer 110 to determine whether an appropriate software driver for the one or more peripheral devices 161 is properly installed and running on computer 110.

In some embodiments, native service 111 may generate and/or transmit a response to the pre-flight cross-domain request to browser 131. The response may comprise information related to whether the cross-domain request can be serviced by native service 111. For example, the response may include information related to whether native service 111 is properly installed and running on computer 110, whether an appropriate software driver for the one or more peripheral devices 161 is properly installed and running on computer 110, and/or other information. Browser 131 may determine whether to send the actual cross-domain request based on the received response from native service 111 and/or send the cross-domain request to native service 111.

In some embodiments, in order to authenticate a request made to native service 111, an authorization ticket may be used. For example, native service 111 may use authorization tickets to authenticate web application 141 (and/or requests originated from web application 141 and/or made to native service 111) to native service 111. If the request is authenticated based on a proper authorization ticket, the request may be authorized to be submitted to native service 111.

In some embodiments, browser 131 may “ping” native service 111. The ping request may cause native service 111 to determine whether web application 141/browser 131 is authorized to access native service 111. If an authorization ticket has not yet been provided by web application 141, it has been provided but failed verification tests, or is otherwise unavailable, native service 111 may be configured to generate a response indicating that the access could not be authorized (e.g., HTTP status 401, access-denied response) and/or that an authorization ticket is required. Ticket module 113 may send the generated response to web application 141 via browser 131 to request for a new authorization ticket.

In some embodiments, web application 141 may generate an authorization ticket and/or store the ticket in ticket database 142 and/or other databases 144. Web application 141 may send the authorization ticket comprising ticket information to native service 111. For example, the ticket information may comprise a time frame (e.g., start time and end time) that indicates how long the ticket should remain valid. Native service 111, upon receiving the ticket and/or ticket information, may certify the ticket by assigning a Ticket ID (e.g., globally unique identifier (guid)) to the authorization ticket. In some embodiments, the Ticket ID may be associated with native service 111 that generated the Ticket ID and/or computer 110 on which native service 111 is installed.

In some embodiments, native service 111 may return the certified ticket comprising ticket certification information to web application 141 where the ticket certification information may comprise the Ticket ID associated with the authorization ticket and/or a time frame that indicates how long the ticket should remain valid. In some embodiments, web application 141 may determine whether the Ticket ID is valid (e.g., the guid is not the ‘empty’ guid). Web application 141 may determine whether the time frame indicated in the ticket certification returned matches the time frame indicated in the ticket information sent. This may prevent an attacker from changing the time frame to a range that is much wider than intended.

In some embodiments, web application 141 may sign the ticket based on the ticket certification. The ticket (e.g., stored in ticket database 142) may be updated with the signature and/or stored as a valid ticket. Web application 141 may send the signed ticket back to native service 111 via browser 131. In some embodiments, the signature may comprise a digital signature that may be used to verify that the ticket was created by an authorized program and/or may be used as a password for the login (e.g., Ticket ID). The signed ticket may comprise the signature, the Ticket ID, the time frame information, and/or other information. In some embodiments, browser 131 may store a copy of the signed ticket in a local storage.

In response to receiving the signed ticket from web application 141, native service 111 may be configured to verify, confirm, and/or store the signed ticket in ticket database 132 and/or other databases 134. For example, native service 111 may check the Ticket ID and time frame to confirm that they match the corresponding information in the signed ticket.

In some embodiments, browser 131 may send the cross-domain request to native service 111. In some embodiments, browser 131 may send the cross-domain request (e.g., the actual cross-domain request) based on the pre-flight cross-domain request.

In some embodiments, native service 111 may be configured to verify the cross-domain request based on an authorization ticket. The cross-domain request may be associated with a Ticket ID, a signature, a timestamp, and/or other authorization information. For example, the timestamp may indicate date and time information at which the cross-domain request was generated and/or sent to native service 111. Native service 111 may identify a signed ticket (e.g., stored in ticket database 132) that corresponds to the Ticket ID associated with the cross-domain request. Native service 111 may verify that the timestamp falls within the time frame specified in and/or associated with the signed ticket. The cross-domain request may be verified against the signature specified in and/or associated with the signed authorization ticket. For example, the signature associated with the cross-domain request may be compared against the signature of the signed authorization ticket to determine whether they match.

In some embodiments, if the authorization ticket has not been provided by web application 141, it has been provided but failed the verification tests, or is otherwise unavailable, native service 111 may request a new authorization ticket from web application 141. Once verified, the cross-domain request and/or one or more functions defined in the request may be serviced and/or processed by native service 111.

In some embodiments, the cross-domain request may comprise one or more functions to be executed on the one or more local peripheral devices 161. The one or more functions defined in the cross-domain request may include retrieving, inserting, modifying, deleting, or otherwise accessing data that may be associated with at least one of the one or more local peripheral devices 161 and/or that may be stored in a data storage coupled to the at least one of the one or more local peripheral devices 161, and/or other functions. In one example, when a user, via browser 131, selects to “take measurements” from a particular medical peripheral device 161 by clicking or otherwise selecting a GUI button displayed on the web page provided by web application 141, native service 111 may obtain a cross-domain request from browser 131 where the one or more functions defined in the cross-domain request include accessing and/or retrieving measurements data from the medical peripheral device 161. The user may take the measurements using the medical peripheral device 161. For example, the user may measure blood pressure using a blood pressure monitoring device.

In some embodiments, in response to the cross-domain request, native service 111 may retrieve and/or obtain the requested measurements data from the one or more medical peripheral devices 161 and/or a data storage coupled to the one or more medical peripheral devices 161. For example, native service 111 may retrieve and/or obtain the blood pressure data from the blood pressure monitoring device. The obtained measurements data may be transmitted to web application 141 via browser 131, and/or stored in a peripheral device content database 143 and/or other databases 144.

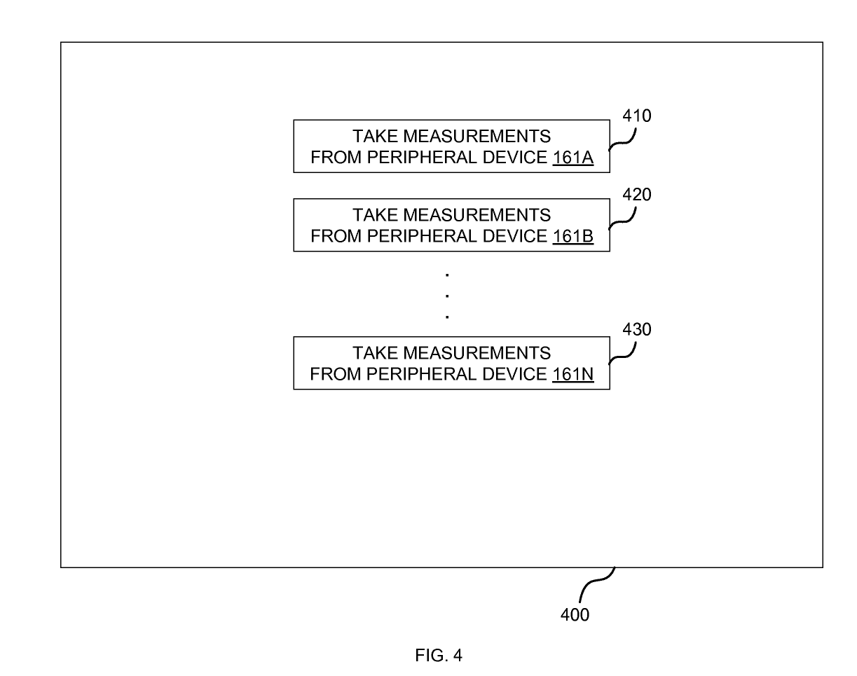

FIG. 4 illustrates a screenshot of an interface for initiating a cross-domain request to obtain measurements data from a medical peripheral device, according to an aspect of the invention. The screenshots illustrated in FIG. 4 and other drawing figures are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting.

Interface 400 and other interfaces described herein may be implemented as a web page communicated from server 101 to a client, an application such as a mobile application executing on the client that receives generates the interface based on information communicated from server 101, and/or other interface. Whichever type of interface is used, server 101 may communicate the data and/or formatting instructions related to the interface to the client, causing the client to generate the various interfaces of FIG. 4 and other drawing figures. Furthermore, server 101 may receive data from the client via the various interfaces, as would be appreciated.

Referring to FIG. 4, web application 141 may provide interface 400 that may be accessed via browser 131. Interface 400 may include GUI elements 410, 420, and/or 430 that, when clicked, pressed, or otherwise selected, may cause browser 131 to send a cross-domain request to native service 111. In some embodiments, the cross-domain request may comprise a request to obtain measurements data from one or more medical peripheral devices 161A, 161B, . . . , 161N. For example, a user may select to “take measurements” from medical peripheral device 161A by clicking or otherwise selecting GUI element 410 included in interface 400. The user may take the measurements using medical peripheral device 161A. For example, the user may measure blood pressure using a blood pressure monitoring device.

In response to the cross-domain request, the requested measurements data may be obtained from medical peripheral device 161A and/or a data storage coupled to medical peripheral device 161A. For example, native service 111 may retrieve and/or obtain the blood pressure data from the blood pressure monitoring device. The obtained measurements data may be transmitted to web application 141 via browser 131, and/or stored in a peripheral device content database 143 and/or other databases 144.

The various user interface components described herein may include hard (e.g, mechanical) or soft (e.g., touch screen or touch pad) buttons, text inputs, icons, selection lists, and/or other user interface objects that may be used to receive an input and/or provide an output. As used herein, the term “selection,” “select,” “selected,” “selecting,” “manipulation,” “manipulating,” etc. with respect to user interface components or members may include, for example, pressing a hard or soft button, clicking, highlighting, hovering over, or otherwise indicating an interest in executing one or more functions related to the selected user interface component.

In the Figures, like numerals represent equivalent elements or features. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system comprising:
a computer device comprising:
a browser configured to access a web application via a communication network;
a native service configured to communicate with one or more peripheral devices locally connected to the computer device, the native service comprising one or more computer program modules; and
one or more processors programmed by the one or more computer program modules, the one or more computer program modules comprising:
a request handling module configured to:
receive a cross-domain request from the browser, the cross-domain request comprising one or more functions to be executed on at least one of the one or more peripheral devices; and
execute the one or more functions on the at least one of the one or more peripheral devices.

2. The system of claim 1, the one or more computer program modules further comprising:
a ticket module configured to:
obtain an authorization ticket that authenticates requests made to the native service, wherein the authorization ticket comprises a time frame that indicates how long the authorization ticket should remain valid and a signature provided by the web application; and
the request handling module further configured to:
determine whether the cross-domain request should be serviced based on the authorization ticket; and
execute the one or more functions on the at least one of the one or more peripheral devices based on determining that the cross-domain request should be serviced.

3. The system of claim 2, wherein the cross-domain request is associated with a timestamp, wherein determining whether the cross-domain request should be serviced based on the authorization ticket comprises verifying that the timestamp is within the time frame of the authorization ticket.

4. The system of claim 1, the one or more computer program modules further comprising:
a pre-request module configured to:
identify a port for communication between the browser and the native service; and
receive the cross-domain request through the identified port.

5. The system of claim 4, wherein the port is a last known port that is previously used by the native service.

6. The system of claim 1, the one or more computer program modules further comprising:
a pre-request module configured to:
receive a pre-flight cross-domain request from the browser prior to receiving the cross-domain request;
determine, upon receiving the pre-flight cross-domain request, whether (a) the native service is properly installed and running on the computer device and (b) an appropriate software driver for the at least one of the one or more peripheral devices is properly installed and running on the computer device; and
transmit, based on the determination, a response to the pre-flight cross-domain request to the browser, wherein the response comprises information related to whether the cross-domain request can be serviced by the native service, based on which the browser determines whether to transmit the cross-domain request to the native service.

7. The system of claim 1, wherein the one or more peripheral devices comprise one or more medical peripheral devices comprising a glucose meter, a pulse oximeter, a blood pressure monitoring device, a weight scale, and/or a spirometer.

8. The system of claim 1, wherein the one or more functions comprise retrieving content from the at least one of the one or more peripheral devices, the request handling module further configured to obtain the content from the at least one of the one or more peripheral devices.

9. The system of claim 8, the request handling module further configured to:
transmit the obtained content to the web application via the browser.

10. The system of claim 1, wherein the system is configured to facilitate communication between the web application and the one or more peripheral devices locally connected to the computer device using the native service running on the computer device.

11. A method implemented in a computer that includes one or more processors configured to execute one or more computer program instructions, the method comprising:
receiving, at a native service, a pre-flight cross-domain request from a browser prior to receiving a cross-domain request;
determining whether the cross-domain request can be serviced by the native service;
generating a response to the pre-flight cross-domain request based on the determination;
receiving the cross-domain request from the browser, the cross-domain request comprising one or more functions to be executed at a locally connected peripheral device; and
executing the one or more functions on the locally connected peripheral device.

12. The method of claim 11, the method further comprising:
identifying a port to be used for communication between the browser and the native service, wherein the cross-domain request is received through the identified port.

13. The method of claim 11, wherein the one or more functions comprise retrieving content from the locally connected peripheral device, the method further comprising:
obtaining the content from the locally connected peripheral device.

14. The method of claim 13, the method further comprising:
transmitting the obtained content to a web application via the browser.

15. A web server configured to provide a web application that comprises one or more GUI objects which, when interacted with by a user using a browser running on a computer device, cause the browser to generate a cross-domain request that comprises one or more functions to be executed on a peripheral device locally connected to the computer device, the web server comprising:
one or more processors configured to:
provide the web application that is accessible through the browser, wherein the web application comprises a GUI object which when interacted with by the user using the browser causes a native application running on the computer device to execute one or more functions on a peripheral device that is locally connected to the computer device;
detect when the GUI object has been interacted with by the user using the browser; and
cause the browser to generate the cross-domain request upon the detection, wherein the cross-domain request comprises the one or more functions to be executed on the peripheral device.

16. The web server of claim 15, wherein the peripheral device comprises a medical peripheral device comprising a glucose meter, a pulse oximeter, a blood pressure monitoring device, a weight scale, and/or a spirometer.

17. The web server of claim 15, the one or more processors further configured to:
obtain a response to the cross-domain request from the native application via the browser.

18. The web server of claim 17, wherein the response to the cross-domain request comprises content obtained from the peripheral device.

19. A method implemented in a computer that includes one or more processors configured to execute one or more computer program instructions, the method comprising:
providing a web application that is accessible through a browser running on a computer device, wherein the web application comprises a GUI object which when interacted with by a user using the browser causes a native application running on the computer device to execute one or more functions on a peripheral device that is locally connected to the computer device;
detecting when the GUI object has been interacted with by the user using the browser; and
causing the browser to generate a cross-domain request upon the detection, wherein the cross-domain request comprises the one or more functions to be executed on the peripheral device.

20. A non-transitory computer readable medium storing computer-readable instructions that, when executed by one or more processors, cause a computer device to:
receive, by a request handling module, a cross-domain request from a browser, the cross-domain request comprising a request to obtain measurement data from a medical peripheral device that is locally connected to the computer device;
obtain, by the request handling module, the measurement data from the medical peripheral device; and
transmit, by the request handling module, the obtained measurement data to the browser.
